(19) United States
(12) Patent Application Publication
(10) Pub. No.: US 2012/0006825 A1
(43) Pub. Date: Jan. 12, 2012

(54) EZ-TRAY COVER

(76) Inventor: Francisco Juan Morla, Guaynabo, PR (US)

(21) Appl. No.: 12/831,191

(22) Filed: Jul. 6, 2010

(51) Int. Cl. B05C 21/00; B65D 25/14

(52) U.S. Cl. 220/495.02

(57) ABSTRACT

A plastic cover is made in a flexible material similar to a plastic garbage bag. It has an expandable elastic band sewed onto the circumference (FIG. 4) and a perforation in the middle which is sealed with a detachable tape (FIG. 5). The cover has an oval shape before it is expanded (FIG. 1). Once it is opened out, it may be adapted to any nine (9) inch rectangular paint tray (FIG. 8-10). It is used so the paint can be poured directly onto the tray cover (FIG. 11) and when done the detachable tape is removed (FIG. 6) and any unused paint is conveniently poured back into the paint can (FIG. 12), avoiding any additional mess.

The invention is a cover to be used on a nine inch (9″) roller paint tray. FIG. 8-10 It will be fabricated in a flexible plastic material (similar to a plastic bag) in white, black or transparent color. The size of the invention is:

Upper side frontal flat view: nineteen (19) inches, vertical and sixteen (16) inches, horizontal. FIG. 1

Backside flat view: there is an opening from elastic to elastic size of twelve (12) inches vertical and eleven (11) inches horizontal. FIG. 3

The circumference vertical width FIG. 2 is a total of twenty six (26) inches elastic to elastic: On the upper side flat view FIG. 1 nineteen (19) inches vertical and from the backside flat view vertical FIG. 3, at one end four (4) inches and the other end three (3) inches.

The circumference horizontal width FIG. 2 is a total of twenty one (21) inches elastic to elastic: on the upper side flat view FIG. 1 sixteen (16) inches horizontal and from the backside flat view horizontal FIG. 3, each side has two and half (2½) inches.

The extremities are gathered by an elastic band (similar to the one used on a shower cap) FIG. 4. In the middle of the plastic cover there is a perforation (a hole) the size of a dime FIG. 7, which is covered with a detachable tape FIG. 5. The detachable tape is located on the side that is adjacent to the tray (inner side) FIG. 10; and has a little ear for easy detachment FIG. 6. The size of the detachable tape is one and a half (1½) vertical and one and a half (1½) horizontal. The purpose of the perforation (hole) is to conveniently drain the remaining paint on the tray back into the can of paint.

### BACKGROUND OF INVENTION

The invention was borne because consumers as me have to invest too much time and effort into the cleanup process that the task of painting involves. The additional time invested is in the washing of the paint tray, the mess that occurs due to the splashing of remaining paint and other situations. Also, the cost incurred due to losing the remaining paint in the procedure and other related costs. If you are going to paint with different colors this invention facilitates the time and money that you want to invest in this task.

Since there is currently no product available in the market that will fulfill this need or facilitate the process I was motivated to design a plastic cover to fit any 9″ roller paint tray.

### BRIEF SUMMARY OF THE INVENTION

The invention is a plastic flexible cover for a 9 inch roller paint tray. The cover is made so that the user can conveniently adapt it onto the tray, since the extremities of the plastic cover unite with an expandable band. When the painting is over and it is time to wrap up, the process will become “EZ”. The extremities of the cover are joined towards the other direction forming a sort of cone shape. At this point you are benefiting from the time and mess that the cleaning up process entails. Also, for the paint remaining in the Cover now at the tip of the cone shape, a detachable tape was designed. It's “EZ”, the consumer can conveniently tear off the tape and empty the remaining paint directly into the can, resulting in a savings related to the time and the amount of product used in the process. The cover is convenient and designed to make the task of painting easier for the user.

### BRIEF DESCRIPTION OF THE SEVERAL VIEWS OF THE DRAWINGS

FIG. 1 This drawing displays the upper side frontal flat view of the cover. An oval shape cover with a perforation located in the middle is observed.

FIG. 2 This drawing displays the cover circumference. The back, side views and gathering of the covers extremities with the elastic band are observed.

FIG. 3 This drawing displays the backside flat view of the cover. The elastic band and the detachable tape are observed.

FIG. 4 This drawing displays a partial view of the extremities of the cover gathered by an elastic band on the backside.

FIG. 5 This drawing is an example of the detachable tape on the inner side adjacent to the tray and is used to cover the perforation (a hole) designed to drain paint.

FIG. 6 This drawing displays the direction in which the detachable tape should be removed using the little ear.

FIG. 7 This drawing displays the perforation located In the middle of the plastic cover once the detachable tape is removed.

FIG. 8 This drawing displays the side view of the cover extended before placing on to a 9 inch roller paint tray. The elastic band is expanded to fit the tray.

FIG. 9 This drawing displays a side view of the cover when on a 9 inch roller paint tray. The elastic band is expanded to fit the tray.

FIG. 10 This drawing displays a frontal view of the cover on the 9 inch roller paint tray. The perforation (a hole) is observed and the perforated lines around the hole indicates there is a detachable tape located on the side that is adjacent to the tray (inner side).

FIG. 11 This drawing displays the utilization of the cover during the initial process when pouring the paint onto the 9 inch roller paint tray.

FIG. 12 This drawing displays the utilization of the cover during the final process when pouring the remaining paint from the cover back to the paint can.

### OATH

The Oath Form PTO/SB/01 is attached to this paper.

### DETAIL DESCRIPTION OF THE INVENTION

### Product

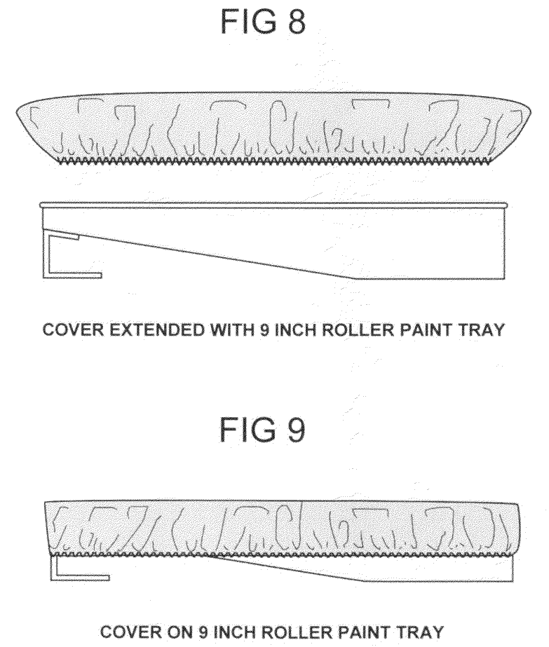

The invention is a cover to be used on a nine inch (9″) roller paint tray. FIG. 8-10 It will be fabricated in a flexible plastic material (similar to a plastic bag) in white, black or transparent color. The size of the invention is:

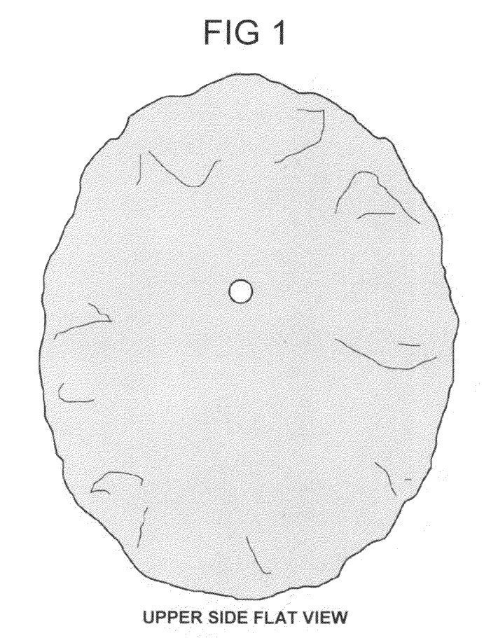

Upper side frontal flat view: nineteen (19) inches, vertical and sixteen (16) inches, horizontal. FIG. 1

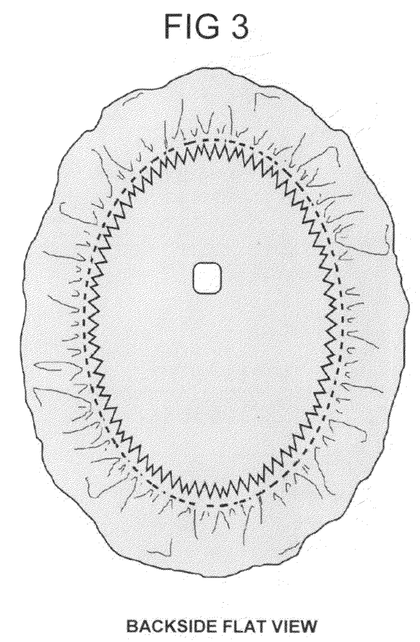

Backside flat view: there is an opening from elastic to elastic size of twelve (12) inches vertical and eleven (11) inches horizontal. FIG. 3

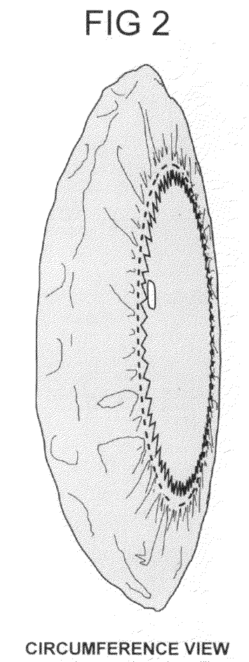

The circumference vertical width FIG. 2 is a total of twenty six (26) inches elastic to elastic: On the upper side flat view FIG. 1 nineteen (19) inches vertical and from the backside flat view vertical FIG. 3, at one end four (4) inches and the other end three (3) inches.

The circumference horizontal width FIG. 2 is a total of twenty one (21) inches elastic to elastic: on the upper side flat view FIG. 1 sixteen (16) inches horizontal and from the backside flat view horizontal FIG. 3, each side has two and half (2½) inches.

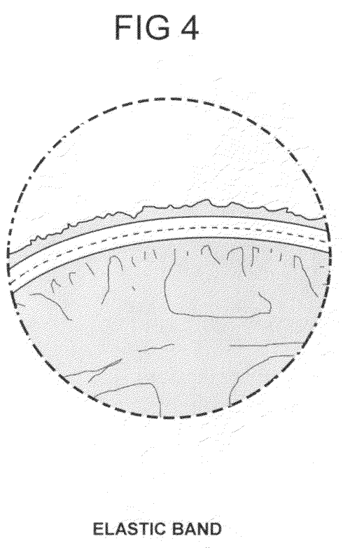

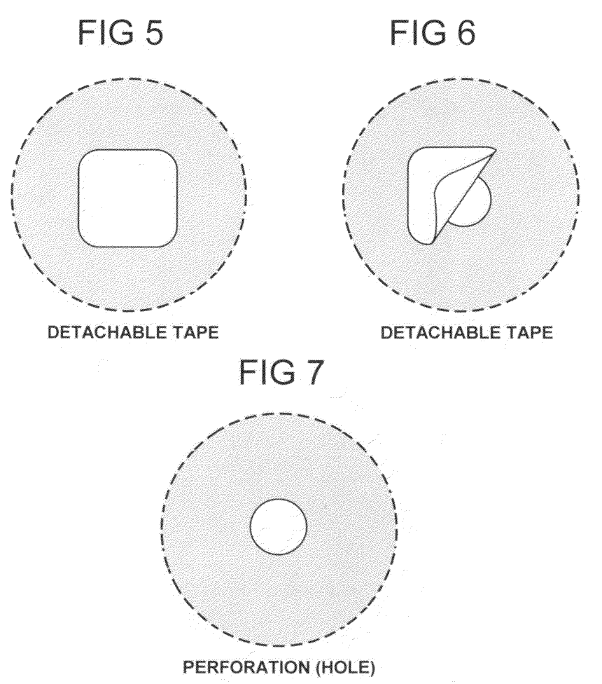

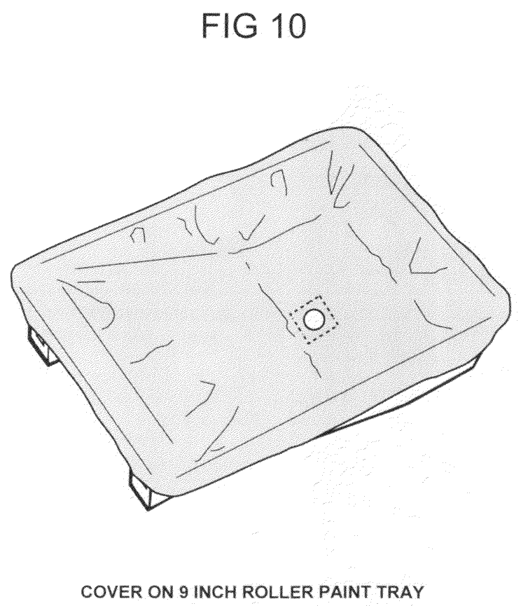

The extremities are gathered by an elastic band (similar to the one used on a shower cap) FIG. 4. In the middle of the plastic cover there is a perforation (a hole) the size of a dime FIG. 7, which is covered with a detachable tape FIG. 5. The detachable tape is located on the side that is adjacent to the tray (inner side) FIG. 10; and has a little ear for easy lifting FIG. 6. The size of the detachable tape is one and a half (1½) vertical and one and a half (1½) horizontal. The purpose of the perforation (hole) is to conveniently drain the remaining paint on the tray back into the can of paint.

The Process—How it's Used

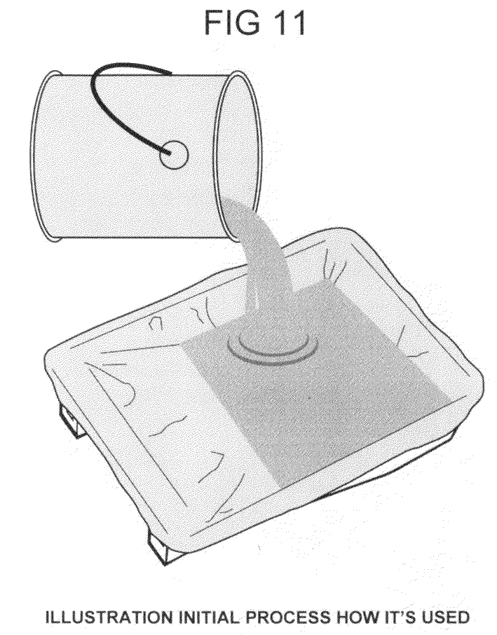

The cover is made so that the user can conveniently adapt it onto the tray, since the extremities of the plastic cover unite with an expandable band. The paint is poured directly onto the tray cover FIG. 11 and it's ready for use. When the painting job is over and it is time to wrap up, the process will become “EZ” with the use of the cover.

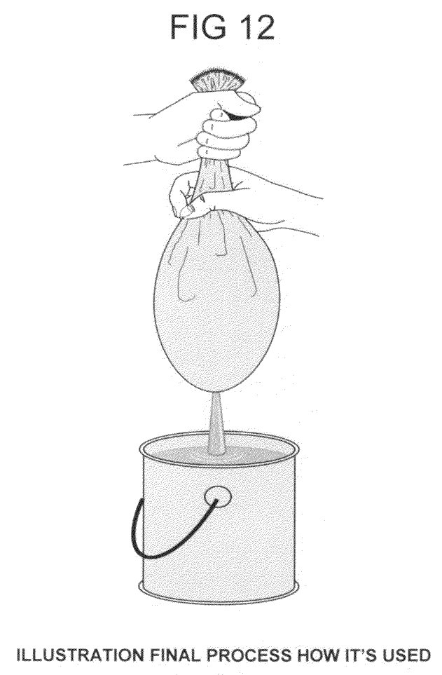

Once you are done painting, the extremities of the cover are joined towards the other direction forming a sort of cone shape. The user should squeeze the plastic from the top to the bottom toward the tip of the cone shape so that all the remaining paint settles towards the tip. At the tip of the cone shape, the user will find for their convenience a detachable tape which should be removed in order to empty the remaining paint back into the paint can or container FIG. 12. When you finished squeezing the remaining paint out of the plastic cover is ready to be disposed of.

### Benefits

The consumer's may benefit from the use of the “EZ-Tray Cover” in many ways since its purpose is to facilitate the process and also, save you money and time. Just some of the benefits would be the savings in the time the user is investing in completing the task of painting and the cost of the products and utilities, etc. Normally you would consider the time in washing the trays after each use and the mess this involves. Also, if you are using more than one color this time will multiply. You save in the cost of the product since the remaining paint is put back directly into the container without the mess of the spilling. Also, the savings in the water consumption and the cleaning of the areas used to wash. By using the “EZ Tray Cover”, when removed, you put a new one on and you are ready for the next job. These are just some examples but there are many other benefits, but in overall the “EZ Tray Cover” is designed to facilitate the process of painting by making it easier for the user.

In today's marketplace you can probably find a variety of 9″ roller paint trays but you will not find a product that offers the consumers the convenience they need like the “EZ-Tray Cover” and for the value.

1- The elastic band is sewed on to the plastic.

2- The detachable tape is adhered to the cover, except for one of the corners, which has an ear for easy lifting.

3- The material of the cover is made of soft, flexible plastic.
